(19) United States
(12) Patent Application Publication
(10) Pub. No.: US 2024/0123767 A1
(43) Pub. Date: Apr. 18, 2024

(54) TIRE

(71) Applicant: Sumitomo Rubber Industries, Ltd., Kobe-shi (JP)

(72) Inventor: Shiho OKABAYASHI, Kobe-shi (JP)

(73) Assignee: Sumitomo Rubber Industries, Ltd., Kobe-shi (JP)

(21) Appl. No.: 18/379,172

(22) Filed: Oct. 12, 2023

(30) Foreign Application Priority Data
Oct. 14, 2022 (JP) 2022-165429

(51) Int. Cl. B60C 11/00; B60C 11/03

(52) U.S. Cl. CPC B60C 11/005; B60C 11/0332; B60C 2011/0025; B60C 2011/0341

(57) ABSTRACT

A tire includes a tread. The tread can include a cap portion and a base portion. The cap portion can include an outer cap portion on an outer side in a width direction of a vehicle when the tire is mounted to the vehicle, and an inner cap portion on an inner side in the width direction of the vehicle when the tire is mounted to the vehicle. A 300% modulus of the inner cap portion can be not less than 5.0 MPa. A 300% modulus of the outer cap portion can be higher than the 300% modulus of the inner cap portion, and can be not greater than 9.0 MPa. A first shoulder land portion can include a boundary between the outer cap portion and the inner cap portion.

### CROSS-REFERENCE TO RELATED APPLICATION(S)

The present application claims priority to Japanese patent application JP 2022-165429, filed on Oct. 14, 2022, the entire contents of which is incorporated herein by reference in its entirety.

### BACKGROUND

### Technical Field

The present disclosure relates to a tire.

### Background Art

A tire comes into contact with a road surface at a tread thereof. The tread may wear. The wear of the tread influences the tire performance. Studies have been conducted to improve wear resistance (for example, Japanese Laid-Open Patent Publication No. 2018-199456).

The tread may include a cap portion which comes into contact with a road surface. The cap portion may be formed from a crosslinked rubber for which wear resistance and grip performance are taken into consideration. When a vehicle corners at a speed of 80 km/h or higher, for instance, wear tends to progress at an outer shoulder portion (portion including a land portion located on the outer side in the width direction of the vehicle when the tire is mounted to the vehicle) in the cap portion.

If the stiffness of the crosslinked rubber forming the cap portion is increased, the tire can suppress the progress of wear. The tire can have improved wear resistance. However, the sound of a road surface hitting the cap portion may become louder, and noise performance may decrease.

### SUMMARY

A tire according to the present disclosure includes a tread extending in a circumferential direction and having an outer circumferential surface that is a tread surface. The tread can have a plurality of circumferential grooves aligned in an axial direction and dividing the tread into a plurality of land portions. The plurality of circumferential grooves can include a first shoulder circumferential groove located on an outer side in a width direction of a vehicle when the tire is mounted to the vehicle, and a second shoulder circumferential groove located on an inner side in the width direction of the vehicle when the tire is mounted to the vehicle. The land portion located outward of the first shoulder circumferential groove in the axial direction can be a first shoulder land portion, and the land portion located outward of the second shoulder circumferential groove in the axial direction can be a second shoulder land portion. The tread can include a cap portion configured to come into contact with a road surface, and a base portion located radially inward of the cap portion and covered with the cap portion. The cap portion can include an outer cap portion located on the outer side in the width direction of the vehicle when the tire is mounted to the vehicle, and an inner cap portion located on the inner side in the width direction of the vehicle when the tire is mounted to the vehicle. A 300% modulus of the inner cap portion can be not less than 5.0 MPa. A 300% modulus of the outer cap portion can be higher than the 300% modulus of the inner cap portion, and can be not greater than 9.0 MPa. The first shoulder land portion can include a boundary between the outer cap portion and the inner cap portion.

### BRIEF DESCRIPTION OF THE DRAWINGS

FIG. 1 is a cross-sectional view showing a part of a tire according to an embodiment of the present disclosure;

FIG. 2 is a development showing a part of a tread pattern;

FIG. 3 is a cross-sectional view showing a portion at a first shoulder circumferential groove; and

FIG. 4 is a cross-sectional view showing a portion at a first shoulder land portion.

### DETAILED DESCRIPTION

The present disclosure has been made in view of such circumstances discussed in the Background section. An object of the present disclosure, among one or more objects, can be to provide a tire that can achieve improvement of wear resistance without decreasing noise performance.

According to the present disclosure, a tire that can achieve improvement of wear resistance without decreasing noise performance can be obtained.

Hereinafter, the present disclosure will be described in detail based on preferred embodiments with appropriate reference to the drawings.

A tire of the present disclosure can be fitted on a rim. The interior of the tire can be filled with air to adjust the internal pressure of the tire. The tire fitted on the rim may also be referred to as tire-rim assembly. The tire-rim assembly can include the rim and the tire fitted on the rim.

In the present disclosure, a state where a tire is fitted on a standardized rim, the internal pressure of the tire is adjusted to a standardized internal pressure, and no load is applied to the tire can be referred to as a standardized state.

In the present disclosure, unless otherwise specified, the dimensions and angles of each component of the tire are measured in the standardized state.

The dimensions and angles of each component in a meridian cross-section of the tire, which cannot be measured in a state where the tire is fitted on the standardized rim, can be measured in a cross-section of the tire obtained by cutting the tire along a plane including a rotation axis. In this measurement, the tire is set such that the distance between right and left beads can be equal to the distance between the beads in the tire that is fitted on the standardized rim.

The standardized rim can mean a rim specified in a standard on which the tire is based. The “standard rim” in the JATMA standard, the “Design Rim” in the IRA standard, and the “Measuring Rim” in the ETRTO standard are standardized rims.

The standardized internal pressure can mean an internal pressure specified in the standard on which the tire is based. The “highest air pressure” in the JATMA standard, the “maximum value” recited in “TIRE LOAD LIMITS AT VARIOUS COLD INFLATION PRESSURES” in the FRA standard, and the “INFLATION PRESSURE” in the ETRTO standard can be regarded as standardized internal pressures.

A standardized load can mean a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard can be regarded as standardized loads.

In the present disclosure, a rubber composition can refer to a composition that is obtained by mixing a base rubber and chemicals in a kneading machine such as a Banbury mixer and that contains the uncrosslinked base rubber. A crosslinked rubber can refer to a crosslinked product, of the rubber composition, obtained by pressurizing and heating the rubber composition. The crosslinked rubber can contain a crosslinked product of the base rubber. The crosslinked rubber may also be referred to as vulcanized rubber, and the rubber composition may also be referred to as unvulcanized rubber.

Examples of the base rubber include natural rubber (NR), butadiene rubber (BR), styrene-butadiene rubber (SBR), isoprene rubber (IR), ethylene-propylene rubber (EPDM), chloroprene rubber (CR), acrylonitrile-butadiene rubber (NBR), and isobutylene-isoprene-rubber (IIR). Examples of the chemicals include reinforcing agents such as carbon black and silica, plasticizers such as aromatic oil, fillers such as zinc oxide, lubricants such as stearic acid, antioxidants, processing aids, sulfur, and vulcanization accelerators. Selection of a base rubber and chemicals, the amounts of the selected chemicals, etc., can be determined as appropriate according to the specifications of components, such as a tread and a sidewall, for which the rubber composition is used.

In the present disclosure, a 300% modulus of a component formed from a crosslinked rubber, of the components included in the tire, can mean the tensile stress at 300% elongation specified in JIS K6251. The 300% modulus can be measured according to the standards of JIS K6251, as an example. In this measurement, a test piece can be sampled from the tire such that the length direction thereof coincides with the circumferential direction of the tire. When a test piece cannot be sampled from the tire, a test piece can be sampled from a sheet-shaped crosslinked rubber (hereinafter, also referred to as rubber sheet) obtained by pressurizing and heating a rubber composition, which can be used for forming the component to be measured, at a temperature of 170° C. for 12 minutes.

In the present disclosure, the 300% modulus can be represented as a 300% modulus at 100° C.

In the present disclosure, a tread portion of the tire can be a portion of the tire that comes into contact with a road surface. A bead portion can be a portion of the tire that is fitted to a rim. A sidewall portion can bef a portion of the tire that extends between the tread portion and the bead portion. The tire can include a tread portion, a pair of bead portions, and a pair of sidewall portions as portions thereof.

### Outline of Embodiments of Present Disclosure

### Configuration 1

A tire according to an aspect of the present disclosure can include a tread extending in a circumferential direction and having an outer circumferential surface that is a tread surface, wherein: the tread can have a plurality of circumferential grooves aligned in an axial direction and dividing the tread into a plurality of land portions; the plurality of circumferential grooves can include a first shoulder circumferential groove located on an outer side in a width direction of a vehicle when the tire is mounted to the vehicle, and a second shoulder circumferential groove located on an inner side in the width direction of the vehicle when the tire is mounted to the vehicle; the land portion located outward of the first shoulder circumferential groove in the axial direction can be a first shoulder land portion; the land portion located outward of the second shoulder circumferential groove in the axial direction can be a second shoulder land portion; the tread can include a cap portion configured to come into contact with a road surface, and a base portion located radially inward of the cap portion and covered with the cap portion; the cap portion can include an outer cap portion located on the outer side in the width direction of the vehicle when the tire is mounted to the vehicle, and an inner cap portion located on the inner side in the width direction of the vehicle when the tire is mounted to the vehicle; a 300% modulus of the inner cap portion may be not less than 5.0 MPa; a 300% modulus of the outer cap portion may be higher than the 300% modulus of the inner cap portion, and may not be greater than 9.0 MPa; and the first shoulder land portion can include a boundary between the outer cap portion and the inner cap portion.

By forming the tire as described above, an axially outer portion of the first shoulder land portion to which a large load is applied when the vehicle corners at a speed of 80 km/h or higher, for instance, can be composed of the outer cap portion having a higher stiffness. At the cap portion of the tire, wear during cornering at a high speed can be suppressed. Since a portion of the cap portion other than the axially outer portion of the first shoulder land portion can be composed of the inner cap portion having a lower stiffness, the sound of a road surface hitting the cap portion can be effectively reduced. The tire can maintain good noise performance.

The tire can achieve improvement of wear resistance without decreasing noise performance.

### Configuration 2

Preferably, in the tire described in [Configuration 1] above, an end, on the tread surface side, of the boundary between the outer cap portion and the inner cap portion can be a first boundary end, an end, on the base portion side, of the boundary can be a second boundary end, the first shoulder circumferential groove can include a groove bottom, an outer groove wall located on an outer side in the axial direction, and an inner groove wall located on an inner side in the axial direction, a boundary between the groove bottom and the outer groove wall can be a reference position of the first shoulder circumferential groove, a distance in the axial direction from the reference position of the first shoulder circumferential groove to the first boundary end can be not less than 3 mm, for instance, and a ratio of the distance in the axial direction to a ground-contact width of the first shoulder land portion can be not greater than 20%, for instance.

By forming the tire as described above, the tire can achieve improvement of wear resistance without decreasing noise performance.

### Configuration 3

Preferably, in the tire described in [Configuration 1] or [Configuration 2] above, in a meridian cross-section of the tire, a distance in the axial direction from an equator plane to the boundary between the outer cap portion and the inner cap portion can gradually increase from the first boundary end toward the second boundary end.

By forming the tire as described above, the stiffness difference in the first shoulder land portion can be gradually changed in the tire, so that occurrence of uneven wear at the first shoulder land portion can be effectively suppressed. The outer cap portion of the tire can sufficiently exhibit its function. The tire can achieve improvement of wear resistance without decreasing noise performance.

### Configuration 4

Preferably, in the tire described in [Configuration 2] or [Configuration 3] above, in the meridian cross-section of the tire, an angle formed between a straight line passing through the first boundary end and the second boundary end and a tangent line tangent to the tread surface at the first boundary end may be not less than 5 degrees and not greater than 80 degrees, for instance.

By forming the tire as described above, the outer cap portion can sufficiently exhibit its function. The tire can achieve improvement of wear resistance without decreasing noise performance.

### Details of Embodiments of Present Disclosure

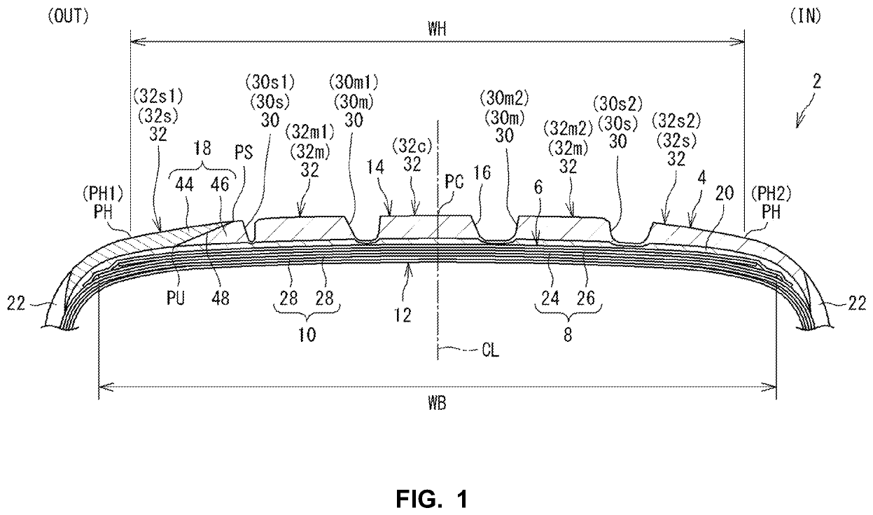

FIG. 1 shows a part of a tire 2 according to an embodiment of the present disclosure. The tire 2 can be a pneumatic tire, for instance, for a passenger car.

FIG. 1 shows a part of a cross-section (hereinafter, meridian cross-section) of the tire 2 taken along a plane including the rotation axis of the tire 2. In FIG. 1, the right-left direction is the axial direction of the tire 2, and the up-down direction is the radial direction of the tire 2. The direction perpendicular to the surface of the drawing sheet of FIG. 1 is the circumferential direction of the tire 2. An alternate long and short dash line CL represents the equator plane of the tire 2.

FIG. 1 shows a tread portion of the tire 2. The tread portion can include a tread 4, a band 6, a belt 8, a carcass 10, and an inner liner 12. In addition to these components, the tire 2 can include components such as beads and clinches.

The components other than the tread 4 can have a general configuration as a component of a tire. The detailed description of the components other than the tread 4 is omitted.

The tread 4 can be formed from a crosslinked rubber. The tread 4 can be located radially outward of the tire 2 and can extend in the circumferential direction. The outer circumferential surface of the tread 4 can be or have a tread surface 14. The tire 2 can come into contact with a road surface at the tread surface 14.

Grooves 16 can be formed on the tread 4. Accordingly, a tread pattern can be formed.

In FIG. 1, a position indicated by reference character PC can be regarded as the point of intersection of the tread surface 14 and the equator plane CL. The point of intersection PC can be the equator of the tire 2. In the case where the groove 16 is located on the equator plane CL, the equator PC can be specified based on a virtual tread surface obtained on the assumption that the groove 16 is not provided thereon. The equator PC can also be a radially outer end of the tire 2.

The tread 4 can include a cap portion 18 and a base portion 20.

The cap portion 18 can include the tread surface 14. The cap portion 18 can come into contact with a road surface. The cap portion 18 can be formed from a crosslinked rubber for which grip performance and wear resistance are taken into consideration. Although described later, the cap portion 18 can be formed using two crosslinked rubbers having different stiffnesses.

The base portion 20 can be located radially inward of the cap portion 18. According to one or more embodiments, the entirety of the base portion 20 can be covered with the cap portion 18. The base portion 20 can be formed from a crosslinked rubber for which low heat generation properties are taken into consideration.

Sidewalls 22 which can form the side surfaces of the tire 2 can be connected to the ends of the tread 4, respectively. Each sidewall 22 can be located radially inward of the tread 4. The sidewall 22 can be located axially outward of the carcass 10. The sidewall 22 can be formed from a crosslinked rubber for which cut resistance is taken into consideration.

A clinch which can come into contact with a rim can be provided radially inward of each sidewall 22. A bead can be provided axially inward of the clinch.

As shown in FIG. 1, the base portion 20 can be located radially outward of the band 6. The base portion 20 can cover the band 6. The belt 8 can be located radially inward of the band 6. According to one or more embodiments, the band 6, such as shown in FIG. 1, can cover the belt 8.

The band 6 can be located between the tread 4 and the belt 8 in the radial direction. The band 6 can be stacked on the belt 8. Optionally, the band 6 of the tire 2 can be a full band. The band 6 may further include a pair of edge bands placed, for instance, so as to be spaced apart from each other in the axial direction. The band 6 may be composed of only a pair of edge bands, according to one or more embodiments of the present disclosure.

According to one or more embodiments, the band 6 can include a helically wound band cord. The band cord can extend substantially in the circumferential direction. A cord formed from an organic fiber can be used as the band cord. Examples of the organic fiber can include nylon fibers, rayon fibers, polyester fibers, and aramid fibers.

In the axial direction, each end of the band 6 can be located outward of an end of the belt 8. The length from the end of the band 6 to the end of the belt 8 may be not less than 3 mm and not greater than 7 mm, as an example.

According to one or more embodiments, the band 6 can have a jointless structure. The band 6 can hold the belt 8.

The belt 8 can be located between the band 6 and the carcass 10 in the radial direction. The belt 8 can be stacked on the carcass 10.

The belt 8 can include an inner layer 24 and an outer layer 26. The inner layer 24 can be stacked on the carcass 10. The outer layer 26 can be located radially outward of the inner layer 24, and can be stacked on the inner layer 24. Each end of the outer layer 26 can be located axially inward of an end of the inner layer 24. The length from the end of the outer layer 26 to the end of the inner layer 24 may be not less than 3 mm and not greater than 10 mm, as an example.

The tire 2 can have one or more layers provided between the inner layer 24 and the outer layer 26. From the viewpoint of mass reduction, the belt 8 can preferably be composed of two layers that are the inner layer 24 and the outer layer 26.

Each of the inner layer 24 and the outer layer 26 can include a large number of belt cords aligned with each other. Each belt cord can be tilted relative to the equator plane CL. The material of the belt cord can be steel, as one example.

In FIG. 1, a length indicated by reference character WB can be regarded as the axial width of the belt 8. The axial width WB can be the distance in the axial direction from a first end to a second end of the belt 8. The above-described equator plane CL can intersect the belt 8 at the center of the axial width WB of the belt 8.

In the tread portion, the carcass 10 can be located between the belt 8 and the inner liner 12. The carcass 10 can extend on and between a pair of the beads.

The carcass 10 can include at least one carcass ply 28. According to one or more embodiments, the carcass 10 of the tire 2 can includes two carcass plies 28. Each of the two carcass plies 28 can be turned up at the bead.

Each carcass ply 28 can include a large number of carcass cords aligned with each other. These carcass cords can intersect the equator plane CL. The carcass 10 of the tire 2 can have a radial structure. In the tire 2, a cord formed from an organic fiber can be used as each carcass cord. Examples of the organic fiber can include nylon fibers, rayon fibers, polyester fibers, and aramid fibers.

The inner liner 12 can be located inward of the carcass 10. The inner liner 12 can form an inner surface of the tire 2. According to one or more embodiments, the inner liner 12 can be formed from a crosslinked rubber that has an excellent air blocking property. The inner liner 12 can maintain the internal pressure of the tire 2.

In FIG. 1, each position indicated by reference character PH can be regarded as a position on the tread surface 14. The position PH can correspond to an axially outer end of a ground-contact surface, of the tire 2, which can come into contact with a road surface.

The ground-contact surface for specifying the position PH can be obtained, for example, using a ground-contact surface shape measuring device. The ground-contact surface can be obtained by setting the camber angle of the tire 2 in the standardized state to 0°, applying a standardized load as a vertical load to the tire 2, and bringing the tire 2 into contact with a flat surface, on this device. The position, on the tread surface 14, corresponding to each axially outer end of the ground-contact surface obtained thus can be the above-described position PH. In the present disclosure, the position PH can be a ground-contact end.

In FIG. 1, the ground-contact end PH located on the left side can be a first ground-contact end PH1, and the ground-contact end PH located on the right side can be a second ground-contact end PH2. When the tire 2 is mounted to a vehicle, the first ground-contact end PH1 can be located on the outer side in the width direction of the vehicle. In FIG. 1, “OUT” represents the outer side in the width direction of the vehicle, and “IN” represents the inner side in the width direction of the vehicle.

In FIG. 1, a length indicated by reference character WH can be regarded as the distance in the axial direction from the first ground-contact end PH1 to the second ground-contact end PH2.

The ratio (WH/WB) of the distance WH in the axial direction obtained in the tire 2 in the standardized state to the axial width WB of the belt 8 may be not less than 85% and not greater than 95%, as an example.

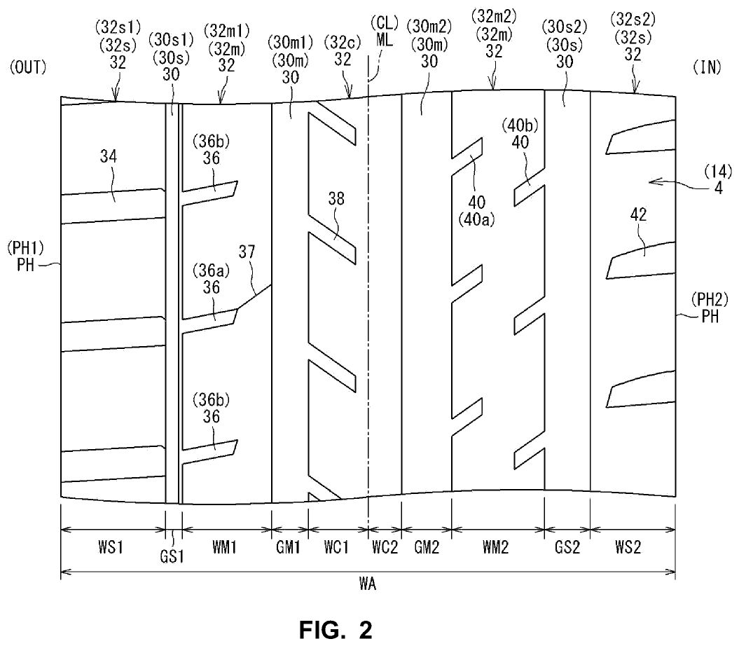

FIG. 2 shows a part of the tread pattern of the tire 2. As described above, the grooves 16 can be formed on the tread 4, whereby the tread pattern can be formed. Among the grooves 16 which form the tread pattern, grooves having a groove width of 1.5 mm or less may be regarded as or also referred to as sipes.

The tread pattern shown in FIG. 2 is an example of the tread pattern according to one or more embodiments of the present disclosure. However, on the tread 4 of the tire 2, according to one or more embodiments of the present disclosure, a tread pattern different from the tread pattern shown in FIG. 2 may be formed.

In FIG. 2, a length indicated by a double-headed arrow WA can be regarded as a ground-contact width of the tread 4. The ground-contact width WA can be the distance in the axial direction from the first ground-contact end PH1 to the second ground-contact end PH2. The ground-contact width WA can be represented as the ground-contact width of the above-described ground-contact surface obtained for specifying the ground-contact end PH.

In FIG. 2, an alternate long and short dash line ML can represent the equator plane CL shown in FIG. 1. When it may be difficult to specify the equator plane CL on the ground-contact surface, the straight line ML can be represented by a center line of the ground-contact width WA.

The tread pattern of the tire 2 can include a circumferential groove 30 continuously extending in the circumferential direction. The tread 4 of the tire 2 can have a plurality of such circumferential grooves 30 aligned in the axial direction. The plurality of circumferential grooves 30 can divide the tread 4 into a plurality of land portions 32. On the tread 4 of the tire 2, four circumferential grooves 30 can be formed, whereby five land portions 32 can be formed therein so as to be aligned in the axial direction.

Among the four circumferential grooves 30, the circumferential groove 30 located on each outermost side in the axial direction can be a shoulder circumferential groove 30s. The shoulder circumferential groove 30s located on the first ground-contact end PH1 side can be a first shoulder circumferential groove 30s1, and the shoulder circumferential groove 30s located on the second ground-contact end PH2 side can be a second shoulder circumferential groove 30s2.

The circumferential groove 30 located axially inward of each shoulder circumferential groove 30s can be a middle circumferential groove 30m. The middle circumferential groove 30m located between the first shoulder circumferential groove 30s1 and the equator plane CL can be a first middle circumferential groove 30m1, and the middle circumferential groove 30m located between the second shoulder circumferential groove 30s2 and the equator plane CL can be a second middle circumferential groove 30m2.

Among the five land portions 32, the land portion 32 located on each outermost side in the axial direction can be a shoulder land portion 32s. The land portion 32 located outward of the first shoulder circumferential groove 30s1 in the axial direction can be a first shoulder land portion 32s1, and the land portion 32 located outward of the second shoulder circumferential groove 30s2 in the axial direction can be a second shoulder land portion 32s2. The first shoulder land portion 32s1 can include the first ground-contact end PH1, and the second shoulder land portion 32s2 can include the second ground-contact end PH2.

Among the five land portions 32, the land portion 32 located axially inward of each shoulder land portion 32s can be a middle land portion 32m. The land portion 32 located between the first shoulder circumferential groove 30s1 and the first middle circumferential groove 30m1 can be a first middle land portion 32m1, and the land portion 32 located between the second shoulder circumferential groove 30s2 and the second middle circumferential groove 30m2 can be a second middle land portion 32m2.

Among the five land portions 32, the land portion 32 located axially inward of the middle land portions 32m can be a center land portion 32c. The center land portion 32c can be located between the first middle circumferential groove 30m1 and the second middle circumferential groove 30m2. The center land portion 32c of the tire 2 can be located on the equator plane CL.

On the first shoulder land portion 32s1, a first shoulder axial groove 34 can be formed as an axial groove. The first shoulder axial groove 34 can have a groove width of at least 2.0 mm or greater, for instance. The first shoulder axial groove 34 can extend between the first ground-contact end PH1 and the first shoulder circumferential groove 30s1. The first shoulder axial groove 34 can extend substantially in the axial direction.

A plurality of such first shoulder axial grooves 34 can be formed on the first shoulder land portion 32s1. These first shoulder axial grooves 34 can be arranged at intervals in the circumferential direction.

In the present disclosure, a groove extending substantially in the axial direction can mean that an angle of the groove with respect to the axial direction is not greater than 15 degrees, for instance.

On the first middle land portion 32m1, a first middle axial groove 36 can be formed as an axial groove. The first middle axial groove 36 can have a groove width of at least 2.0 mm or greater, for instance. The groove width of the first middle axial groove 36 can be smaller than the groove width of the first shoulder axial groove 34.

The first middle axial groove 36 can have an end (hereinafter, first end) in the first middle land portion 32m1. The first middle axial groove 36 can extend between the first end and the first shoulder circumferential groove 30s1. The first middle axial groove 36 can be connected at a second end thereof to the first shoulder circumferential groove 30s1. The first middle axial groove 36 can extend substantially in the axial direction.

A plurality of such first middle axial grooves 36 can be formed on the first middle land portion 32m1. These first middle axial grooves 36 can be arranged at intervals in the circumferential direction. According to one or more embodiments, each first middle axial groove 36 can be placed so as to oppose the first shoulder axial groove 34 across the first shoulder circumferential groove 30s1.

As shown in FIG. 2, the plurality of first middle axial grooves 36 can include first middle axial grooves 36a each connected to the first middle circumferential groove 30m1 by a sipe 37. The first middle axial grooves 36 can include the first middle axial grooves 36a each connected to the first middle circumferential groove 30m1 by the sipe 37, and first middle axial grooves 36b not connected to the first middle circumferential groove 30m1. The first middle axial grooves 36a and the first middle axial grooves 36b can be alternately arranged in the circumferential direction.

On the center land portion 32c, a center axial groove 38 can be formed as an axial groove. The center axial groove 38 has a groove width of at least 2.0 mm or greater. The center axial groove 38 can have a groove width substantially equal to the groove width of the first middle axial groove 36.

The center axial groove 38 can have an end (hereinafter, first end) in the center land portion 32c. The center axial groove 38 can extend between the first end and the first middle circumferential groove 30m1. The center axial groove 38 can be connected at a second end thereof to the first middle circumferential groove 30m1.

The second end of the center axial groove 38 can be located axially outward of the equator plane CL. The center axial groove 38 can be located between the first middle circumferential groove 30m1 and the equator plane CL.

The center axial groove 38 can be tilted relative to the axial direction. The second end of the center axial groove 38 can be positioned closer to the above-described first middle axial groove 36a than the first end thereof is.

A plurality of such center axial grooves 38 can be formed on the center land portion 32c. These center axial grooves 38 can be arranged at intervals in the circumferential direction. Each center axial groove 38 can be located between two first middle axial grooves 36 adjacent to each other in the circumferential direction.

On the second middle land portion 32m2, a second middle axial groove 40 can be formed as an axial groove. The second middle axial groove 40 can have a groove width of at least 2.0 mm or greater. The second middle axial groove 40 can have a groove width substantially equal to the groove width of the center axial groove 38.

As shown in FIG. 2, the second middle axial groove 40 can be formed on each of an inner portion and an outer portion of the second middle land portion 32m2. In the tire 2, the second middle axial groove 40 formed on the inner portion of the second middle land portion 32m2 may also be referred to as inner middle axial groove 40a, and the second middle axial groove 40 formed on the outer portion of the second middle land portion 32m2 may also be referred to as outer middle axial groove 40b.

Each of the inner middle axial groove 40a and the outer middle axial groove 40b can have an end (hereinafter, first end) in the second middle land portion 32m2. The inner middle axial groove 40a can extend between the first end and the second middle circumferential groove 30m2. The inner middle axial groove 40a can be connected at a second end thereof to the second middle circumferential groove 30m2. The outer middle axial groove 40b can extend between the first end and the second shoulder circumferential groove 30s2. The outer middle axial groove 40b can be connected at a second end thereof to the second shoulder circumferential groove 30s2.

The inner middle axial groove 40a and the outer middle axial groove 40b can be tilted relative to the axial direction. The direction of tilt of the inner middle axial groove 40a and the direction of tilt of the outer middle axial groove 40b may be the same, according to one or more embodiments of the present disclosure. The direction of tilt of the inner middle axial groove 40a and the outer middle axial groove 40b can be opposite to the direction of tilt of the center axial groove 38.

A plurality of such inner middle axial grooves 40a and a plurality of such outer middle axial grooves 40b can be formed on the second middle land portion 32m2. The inner middle axial grooves 40a and the outer middle axial grooves 40b can be alternately arranged in the circumferential direction. A pair of second middle axial grooves 40 composed of the inner middle axial groove 40a and the outer middle axial groove 40b can be located between two center axial grooves 38 adjacent to each other in the circumferential direction.

On the second shoulder land portion 32s2, a second shoulder axial groove 42 can be formed as an axial groove. The second shoulder axial groove 42 can have a groove width of at least 2.0 mm or greater. The second shoulder axial groove 42 can have a groove width substantially equal to the groove width of the first shoulder axial groove 34.

The second shoulder axial groove 42 can have an end (hereinafter, first end) in the second shoulder land portion 32s2. The second shoulder axial groove 42 can extend between the first end and the second ground-contact end PH2. According to one or more embodiments of the present disclosure, the second shoulder axial groove 42 may not be connected to the second shoulder circumferential groove 30s2.

The second shoulder axial groove 42 can extend substantially in the axial direction. A plurality of such second shoulder axial grooves 42 formed on the second shoulder land portion 32s2. These second shoulder axial grooves 42 can be arranged at intervals in the circumferential direction. Each second shoulder axial groove 42 can be located between two first shoulder axial grooves 34 adjacent to each other in the circumferential direction.

In FIG. 2, a double-headed arrow GS1 can indicate the opening width of the first shoulder circumferential groove 30s1. A double-headed arrow GM1 can indicate the opening width of the first middle circumferential groove 30m1. A double-headed arrow GM2 can indicate the opening width of the second middle circumferential groove 30m2. A double-headed arrow GS2 can indicate the opening width of the second shoulder circumferential groove 30s2. The opening widths GS1, GM1, GM2, and GS2 can be specified using the above-described ground-contact surface obtained for specifying the ground-contact end PH.

In FIG. 2, a length indicated by a double-headed arrow WS1 can be a ground-contact width of the first shoulder land portion 32s1. The ground-contact width WS1 can be the distance in the axial direction from the first ground-contact end PH1 to the outer opening edge of the first shoulder circumferential groove 30s1. A length indicated by a double-headed arrow WM1 can be a ground-contact width of the first middle land portion 32m1. The ground-contact width WM1 can be the distance in the axial direction from the inner opening edge of the first shoulder circumferential groove 30s1 to the outer opening edge of the first middle circumferential groove 30m1. A length indicated by a double-headed arrow WC1 can be a ground-contact width of an outer portion of the center land portion 32c. The ground-contact width WC1 can be the distance in the axial direction from the inner opening edge of the first middle circumferential groove 30m1 to the equator plane CL. A length indicated by a double-headed arrow WC2 can be a ground-contact width of an inner portion of the center land portion 32c. The ground-contact width WC2 can be the distance in the axial direction from the equator plane CL to the inner opening edge of the second middle circumferential groove 30m2. A length indicated by a double-headed arrow WM2 can be a ground-contact width of the second middle land portion 32m2. The ground-contact width WM2 can be the distance in the axial direction from the outer opening edge of the second middle circumferential groove 30m2 to the inner opening edge of the second shoulder circumferential groove 30s2. A length indicated by a double-headed arrow WS2 can be a ground-contact width of the second shoulder land portion 32s2. The ground-contact width WS2 can be the distance in the axial direction from the outer opening edge of the second shoulder circumferential groove 30s2 to the second ground-contact end PH2.

The ground-contact widths WS1, WM1, WC1, WC2, WM2, and WS2 can be specified using the above-described ground-contact surface for obtaining the ground-contact end PH.

In the tire 2, according to one or more embodiments of the present disclosure, the ground-contact width WS1 of the first shoulder land portion 32s1 can be larger than the ground-contact width WS2 of the second shoulder land portion 32s2. The ground-contact width WC1 of the outer portion of the center land portion 32c can be larger than the ground-contact width WC2 of the inner portion of the center land portion 32c. The first middle land portion 32m1 can have the ground-contact width WM1 substantially equal to the ground-contact width WM2 of the second middle land portion 32m2.

The fact that the ground-contact width WM1 and the ground-contact width WM2 may be substantially equal to each other can mean that the ratio (WM1/WM2) of the ground-contact width WM1 to the ground-contact width WM2 may be not less than 0.95 and not greater than 1.05, as an example.

According to one or more embodiments of the present disclosure, the opening width GS1 of the first shoulder circumferential groove 30s1 can be smaller than the opening width GS2 of the second shoulder circumferential groove 30s2. Additionally or alternatively, the opening width GM1 of the first middle circumferential groove 30m1 can be smaller than the opening width GM2 of the second middle circumferential groove 30m2. Among the circumferential grooves 30, the circumferential groove 30 having the largest opening width can be the second middle circumferential groove 30m2, and the circumferential groove 30 having the smallest opening width can be the first shoulder circumferential groove 30s1.

As described above, the cap portion 18 of the tire 2 can be formed using two crosslinked rubbers having different stiffnesses. The cap portion 18 can include an outer cap portion 44 and an inner cap portion 46. The outer cap portion 44 can have a stiffness higher than that of the inner cap portion 46. Specifically, a 300% modulus of the inner cap portion 46 may be not less than 5.0 MPa, and a 300% modulus of the outer cap portion 44 can be higher than the 300% modulus of the inner cap portion 46 and may be not greater than 9.0 MPa, as examples.

In FIG. 1, a position indicated by reference character PS can be the end, on the tread surface 14 side, of a boundary 48 between the outer cap portion 44 and the inner cap portion 46. The end PS may also be referred to as first boundary end. The first boundary end PS of the tire 2 can be included in the outer surface of the land portion 32. A position indicated by reference character PU can be the end, on the base portion 20 side, of the boundary 48. The end PU may also referred be to as second boundary end. The second boundary end PU of the tire 2 can be included in the interface between the cap portion 18 and the base portion 20.

The boundary 48 can be the interface between the outer cap portion 44 and the inner cap portion 46. The cap portion 18 can be composed of two components that are the outer cap portion 44 and the inner cap portion 46. Optionally, the cap portion 18 can consist of the outer cap portion 44 and the inner cap portion 46.

The outer cap portion 44 can include the first ground-contact end PH1, and the inner cap portion 46 can include the equator PC and the second ground-contact end PH2. When the tire 2 is mounted to the vehicle, the outer cap portion 44 can be located on the outer side in the width direction of the vehicle, and the inner cap portion 46 can be located on the inner side in the width direction of the vehicle.

As shown in FIG. 1, the boundary 48 between the outer cap portion 44 and the inner cap portion 46 may be included in the first shoulder land portion 32s1. An axially outer portion of the first shoulder land portion 32s1 including the first ground-contact end PH1 can be composed of the outer cap portion 44 having a higher stiffness. The portion of the cap portion 18 other than the portion composed of the outer cap portion 44 can be composed of the inner cap portion 46 having a stiffness lower than that of the outer cap portion 44. In the first shoulder land portion 32s1 shown in FIG. 1, the first boundary end PS can be included in the outer surface thereof.

In the tire 2, the axially outer portion of the first shoulder land portion 32s1 to which a large load is applied, for instance, when the vehicle corners at a speed of 80 km/h or higher, can be composed of the outer cap portion 44 having a higher stiffness. At the cap portion 18 of the tire 2, wear during cornering at a high speed can be suppressed.

Since the portion of the cap portion 18 other than the axially outer portion of the first shoulder land portion 32s1 can be composed of the inner cap portion 46 having a lower stiffness, the sound of a road surface hitting the cap portion 18 can be effectively reduced. The tire 2 can maintain good noise performance.

Moreover, since the 300% modulus of the inner cap portion 46 may be not less than 5.0 MPa, wear of the inner cap portion 46, to which a smaller load is applied during running than to the outer cap portion 44, can also be effectively suppressed.

Furthermore, since the 300% modulus of the outer cap portion 44 may be not greater than 9.0 MPa, the influence of the outer cap portion 44 on noise performance can also be effectively suppressed.

The tire 2 can achieve improvement of wear resistance without decreasing noise performance.

The outer cap portion 44 of the tire 2 can contribute to suppressing wear during cornering at a high speed. From the viewpoint of being able to achieve further improvement of wear resistance, the 300% modulus of the outer cap portion 44 can be preferably not less than 8.0 MPa, for instance.

The inner cap portion 46 of the tire 2 can contribute to reducing the sound of a road surface hitting the cap portion 18. From the viewpoint of being able to effectively maintain good noise performance, the 300% modulus of the inner cap portion 46 can be preferably not greater than 7.0 MPa, for instance.

As described above, the 300% modulus of the outer cap portion 44 can be higher than the 300% modulus of the inner cap portion 46. From the viewpoint of being able to well-balance noise performance and wear resistance, the ratio of the 300% modulus of the outer cap portion 44 to the 300% modulus of the inner cap portion 46 can be preferably not less than 1.1, more preferably not less than 1.2, and further preferably not less than 1.3. From the same viewpoint, this ratio can be preferably not greater than 1.8, more preferably not greater than 1.7, and further preferably not greater than 1.6.

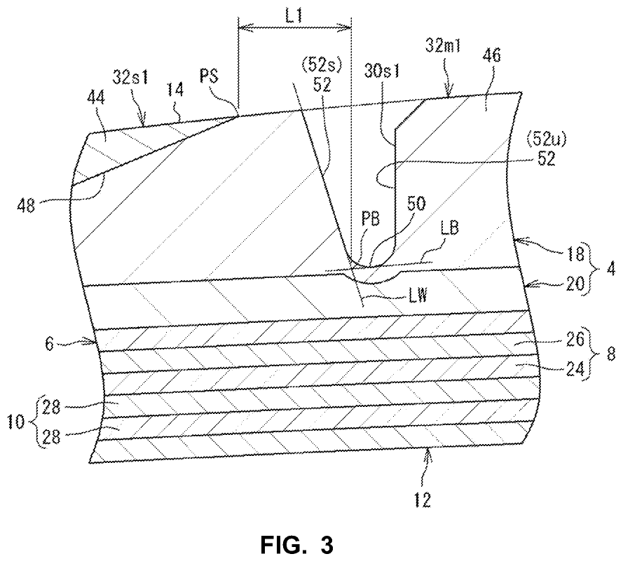

FIG. 3 shows a portion at the first shoulder circumferential groove 30s1. FIG. 3 shows a part of the meridian cross-section shown in FIG. 1.

The first shoulder circumferential groove 30s1 of the tire 2 can include a groove bottom 50 and a pair of groove walls 52 extending from the groove bottom 50 toward the tread surface 14 side. Of the pair of groove walls 52, the groove wall 52 located on the outer side in the axial direction can be an outer groove wall 52s, and the groove wall 52 located on the inner side in the axial direction can be an inner groove wall 52u. The first shoulder circumferential groove 30s1 can include the groove bottom 50, the outer groove wall 52s, and the inner groove wall 52u.

In FIG. 3, a position indicated by reference character PB can be the boundary between the groove bottom 50 and the outer groove wall 52s. The boundary PB can be represented as the point of intersection of a tangent line LB of the groove bottom 50 and an extension line LW of a contour line of the outer groove wall 52s. In the present disclosure, the boundary PB between the groove bottom 50 and the outer groove wall 52s can be a reference position of the first shoulder circumferential groove 30s1. A length indicated by reference character L1 can be the distance in the axial direction from the reference position PB to the first boundary end PS.

As shown in FIG. 3, the first boundary end PS of the boundary 48 between the outer cap portion 44 and the inner cap portion 46 can be located axially outward of the first shoulder circumferential groove 30s1. The first boundary end PS can be located axially outward of the reference position PB of the first shoulder circumferential groove 30s1 so as to be spaced apart therefrom by a predetermined distance. Specifically, the distance L1 in the axial direction from the reference position PB to the first boundary end PS can be preferably not less than 3 mm, for instance. Accordingly, concentration of strain on the groove bottom 50 of the first shoulder circumferential groove 30s1 can be suppressed. At the boundary 48, peeling of the outer cap portion 44 from the inner cap portion 46 can be suppressed. The outer cap portion 44 of the tire 2 can stably exhibit its function. From this viewpoint, the distance L1 in the axial direction can be more preferably not less than 4 mm, for instance.

In the tire 2, the ratio (L1/WS1) of the distance L1 in the axial direction from the reference position PB to the first boundary end PS, to the ground-contact width WS1 of the first shoulder land portion 32s1, may be preferably not greater than 20%, as an example. Accordingly, in the tire 2, the stiffness difference between the outer side and the inner side in the first shoulder land portion 32s1 to which a large load is applied during cornering at a high speed can be reduced. In the tire 2, wear of the inner portion, of the first shoulder land portion 32s1, composed of the inner cap portion 46 can be effectively suppressed. From this viewpoint, the ratio (L1/WS1) can be more preferably not greater than 15%, for instance.

In the tire 2, from the viewpoint of being able to achieve improvement of wear resistance without decreasing noise performance, more preferably, the distance L1 in the axial direction may be not less than 3 mm, and the ratio (L1/WS1) may be not greater than 20%, as examples.

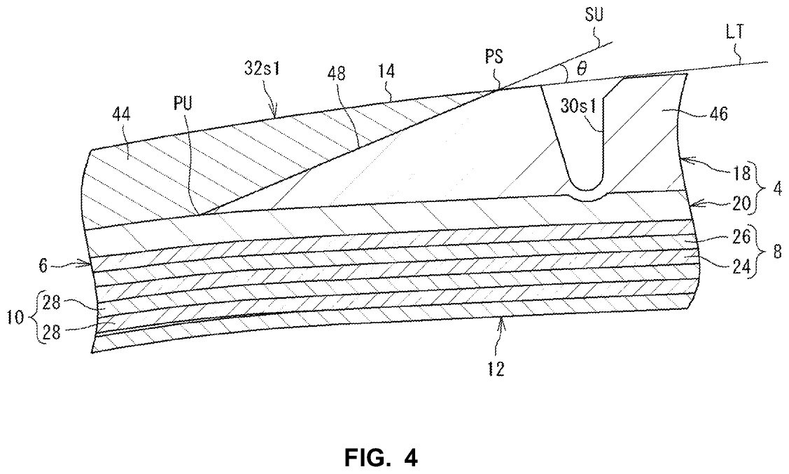

FIG. 4 shows a portion at the first shoulder land portion 32s1. FIG. 4 shows a part of the meridian cross-section shown in FIG. 1.

As shown in FIG. 4, the boundary 48 between the outer cap portion 44 and the inner cap portion 46 can extend so as to be tilted relative to the axial direction. The second boundary end PU can be located axially outward of the first boundary end PS. In other words, the distance in the axial direction from the equator plane CL to the boundary 48 between the outer cap portion 44 and the inner cap portion 46 can gradually increase from the first boundary end PS toward the second boundary end PU.

The boundary 48 may be formed such that the position of the second boundary end PU coincide with the position of the first boundary end PS in the axial direction.

In the first shoulder land portion 32s1, the boundary 48 can be a change of stiffness. Therefore, by forming the first shoulder land portion 32s1 such that the boundary 48 is tilted as shown in FIG. 4, the stiffness difference in the first shoulder land portion 32s1 can be gradually changed in the tire 2, so that occurrence of uneven wear at the first shoulder land portion 32s1 can be effectively suppressed. In this case, the outer cap portion 44 can sufficiently exhibit its function. From this viewpoint, the boundary 48 can be preferably formed such that the distance in the axial direction from the equator plane CL to the boundary 48 between the outer cap portion 44 and the inner cap portion 46 gradually increases from the first boundary end PS toward the second boundary end PU. In other words, the boundary 48 between the outer cap portion 44 and the inner cap portion 46 in the first shoulder land portion 32s1 can be preferably formed such that the second boundary end PU is located axially outward of the first boundary end PS. In this case, a contour line of the boundary 48 in the meridian cross-section may be curved, or may be represented by a straight line. In the case where the contour line is curved, from the viewpoint of suppressing exposure of the base portion 20, the contour line can be preferably curved toward the base portion 20 side.

In FIG. 4, a solid line SU can be regarded as a straight line passing through the first boundary end PS and the second boundary end PU. A solid line LT can be a tangent line tangent to the tread surface 14 at the first boundary end PS. An angle θ can be an angle formed between the straight line SU and the tangent line LT. The angle θ can be an angle formed between the straight line SU passing through the first boundary end PS and the second boundary end PU, and the tangent line LT tangent to the tread surface 14 at the first boundary end PS in the meridian cross-section of the tire 2. The angle θ may also be referred to as tilt angle of the boundary 48.

In the tire 2, the tilt angle θ of the boundary 48 can be preferably not less than 5 degrees and not greater than 80 degrees, for instance.

When the tilt angle θ is set to be not less than 5 degrees, the first shoulder land portion 32s1 can be formed such that the outer cap portion 44 has a required volume. The tire 2 can effectively suppress wear, and can appropriately control the exposure amount of the inner cap portion 46. In the tire 2, the outer cap portion 44 can sufficiently exhibit its function. From this viewpoint, the tilt angle θ can be more preferably not less than 15 degrees and further preferably not less than 25 degrees.

When the tilt angle θ is set so as to be not greater than 80 degrees, the stiffness difference in the first shoulder land portion 32s1 can be gradually changed in the tire 2, so that occurrence of uneven wear at the first shoulder land portion 32s1 can be effectively suppressed. In this case as well, the outer cap portion 44 can sufficiently exhibit its function. From this viewpoint, the tilt angle θ can be more preferably not greater than 70 degrees and further preferably not greater than 60 degrees, for instance.

As described above, in the tire 2, the outer cap portion 44 can be provided in the first shoulder land portion 32s1. The portion of the cap portion 18 other than the outer cap portion 44 can be composed of the inner cap portion 46.

From the viewpoint that the tire 2 is able to achieve improvement of wear resistance without decreasing noise performance, the ratio (WS1/WA) of the ground-contact width WS1 of the first shoulder land portion 32s1 to the ground-contact width WA can be preferably not less than 15% and not greater than 20%, for instance.

As described above, in the tire 2, the ground-contact width WS1 of the first shoulder land portion 32s1 can be larger than the ground-contact width WS2 of the second shoulder land portion 32s2. In the tire 2, the outer cap portion 44, which forms a part of the first shoulder land portion 32s1, can sufficiently exhibit its function. From this viewpoint, the ratio (WS1/WS2) of the ground-contact width WS1 of the first shoulder land portion 32s1 to the ground-contact width WS2 of the second shoulder land portion 32s2 can be preferably not less than 120% and not greater than 130%, for instance.

The center land portion 32c of the tire 2 can be formed such that the ground-contact width WC1 of the outer portion thereof is larger than the ground-contact width WC2 of the inner portion thereof. The center land portion 32c can contribute to improvement of wear resistance without decreasing noise performance. From this viewpoint, the ratio (WC1/WC2) of the ground-contact width WC1 of the outer portion to the ground-contact width WC2 of the inner portion can be preferably not less than 170% and not greater than 180%.

As shown in FIG. 1, the first shoulder circumferential groove 30s1 and the first middle circumferential groove 30m1 can be located in a zone from the equator plane CL to the first ground-contact end PH1, and the second middle circumferential groove 30m2 and the second shoulder circumferential groove 30s2 can be located in a zone from the equator plane CL to the second ground-contact end PH2. From the viewpoint that each of the outer cap portion 44 and the inner cap portion 46 can exhibit its function, the cap portion 18 in the zone from the equator plane CL to the first ground-contact end PH1 preferably can have a stiffness higher than that of the cap portion 18 in the zone from the equator plane CL to the second ground-contact end PH2. From this viewpoint, the total (GS1+GM1) of the opening width GS1 of the first shoulder circumferential groove 30s1 and the opening width GM1 of the first middle circumferential groove 30m1 can be preferably smaller than the total (GM2+GS2) of the opening width GM2 of the second middle circumferential groove 30m2 and the opening width GS2 of the second shoulder circumferential groove 30s2. Specifically, the ratio ((GS1+GM1)/(GM2+GS2)) of the total (GS1+GM1) to the total (GM2+GS2) can be more preferably not less than 50% and not greater than 60%, for instance.

As described above, in the tire 2, among the circumferential grooves 30, the circumferential groove 30 having the largest opening width can be the second middle circumferential groove 30m2. The second middle circumferential groove 30m2 can be formed on the inner cap portion 46. From the viewpoint that the inner cap portion 46 can contribute to maintaining good noise performance, the ratio (GM2/WA) of the opening width GM2 of the second middle circumferential groove 30m2 to the ground-contact width WA can be preferably not less than 5% and not greater than 10%, for instance.

As described above, in the tire 2, the circumferential groove 30 having the smallest opening width can be the first shoulder circumferential groove 30s1. The first shoulder land portion 32s1 in which the outer cap portion 44 is provided can be located axially outward of the first shoulder circumferential groove 30s1. The first shoulder circumferential groove 30s1 having the small opening width GS1 can contribute to exhibition of the function of the outer cap portion 44. From this viewpoint, the ratio (GS1/GM2) of the opening width GS1 of the first shoulder circumferential groove 30s1 to the opening width GM2 of the second middle circumferential groove 30m2 can be preferably not less than 30% and not greater than 40%, for instance.

As is obvious from the above description, according to one or more embodiments of the present disclosure, the tire 2 that can achieve improvement of wear resistance without decreasing noise performance, is obtained.

### EXAMPLES

Hereinafter, the present disclosure will be described in further detail by means of examples, etc., but the present disclosure is not limited to these examples.

### Example 1

A pneumatic tire for a passenger car (tire designation=235/35ZR19) having the basic structure shown in FIG. 1 and having specifications shown in Table 1 below was obtained.

A 300% modulus Mu of the inner cap portion, a 300% modulus Ms of the outer cap portion, the ratio (L1/WS1), and the tilt angle θ of the boundary were set as shown in Table 1 below.

### Comparative Example 1

A tire of Comparative Example 1 is a conventional tire. In Comparative Example 1, the cap portion was formed from a single crosslinked rubber. As described in the cell for “Ms” in Table 1, the 300% modulus of the cap portion was 8.0 MPa.

### Examples 2 and 3 and Comparative Examples 2 and 3

Tires of Examples 2 and 3 and Comparative Examples 2 and 3 were obtained in the same manner as Example 1, except that the 300% modulus Mu of the inner cap portion, the 300% modulus Ms of the outer cap portion, the ratio (L1/WS1), and the tilt angle θ of the boundary were set as shown in Table 1 below.

[Noise Performance]

Test tires were each fitted onto a rim (size=19×8.0J) and inflated with air to adjust the internal pressure thereof to 240 kPa. The tires were mounted to a test vehicle (passenger car). The noise in the vehicle interior was measured when the test vehicle was driven at a speed of 100 km/h on a test course having a dry asphalt surface. The results are shown in Table 1 below as indexes with the result of Comparative Example 1 being regarded as 100. The higher the value is, the better the noise performance is.

[Wear Resistance]

Test tires were each fitted onto a rim (size=19×8.0J) and inflated with air to adjust the internal pressure thereof to 240 kPa. The tires were mounted to a test vehicle (passenger car). The test vehicle was driven on a test course having a dry asphalt surface. After driving, a groove depth Cr of the second middle circumferential groove and a groove depth Sh of the first shoulder axial groove were measured and the ratio (Sh/Cr) was obtained. The results are shown in Table 1 below as indexes with the result of Comparative Example 1 being regarded as 100. The higher the value is, the better the wear resistance is.

TABLE 1

| | Comp. | Comp. | Comp. | Ex. | Ex. | Ex. |
|---|---|---|---|---|---|---|
| | Ex. 1 | Ex. 2 | Ex. 3 | 2 | 3 | 1 |
| Mu [MPa] | — | 4.0 | 6.0 | 6.0 | 6.0 | 6.0 |
| Ms [MPa] | 8.0 | 8.5 | 10.0 | 8.5 | 8.5 | 8.5 |
| L1/WS1 [%] | — | 40 | 40 | 40 | 10 | 10 |
| θ [°] | — | 90 | 90 | 90 | 90 | 40 |
| Noise | 100 | 105 | 95 | 105 | 105 | 105 |
| performance | | | | | | |
| Wear resistance | 100 | 95 | 105 | 103 | 106 | 110 |

As shown in Table 1, it is confirmed that, in each Example, improvement of wear resistance is achieved without decreasing noise performance. From the evaluation results, advantages of the present disclosure are clear.

The above-described technology capable of achieving improvement of wear resistance without decreasing noise performance can also be applied to various tires.

What is claimed is:

1. A tire comprising a tread extending in a circumferential direction and having an outer circumferential surface that is a tread surface, wherein
the tread has a plurality of circumferential grooves aligned in an axial direction and dividing the tread into a plurality of land portions,
the plurality of circumferential grooves include a first shoulder circumferential groove on an outer side in a width direction of a vehicle when the tire is mounted to a vehicle, and a second shoulder circumferential groove on an inner side in the width direction of the vehicle when the tire is mounted to the vehicle,
the land portion outward of the first shoulder circumferential groove in the axial direction is a first shoulder land portion,
the land portion outward of the second shoulder circumferential groove in the axial direction is a second shoulder land portion,
the tread includes a cap portion to come into contact with a road surface, and a base portion radially inward of the cap portion and covered with the cap portion,
the cap portion includes an outer cap portion on the outer side in the width direction of the vehicle, and an inner cap portion on the inner side in the width direction,
a 300% modulus of the inner cap portion is not less than 5.0 MPa,
a 300% modulus of the outer cap portion is higher than the 300% modulus of the inner cap portion, and is not greater than 9.0 MPa, and
the first shoulder land portion includes a first boundary between the outer cap portion and the inner cap portion.

2. The tire according to claim 1, wherein
a first end, on the tread surface side, of the first boundary between the outer cap portion and the inner cap portion is a first boundary end,
a second end, on the base portion side, of the first boundary is a second boundary end,
the first shoulder circumferential groove includes a groove bottom, an outer groove wall on an outer side in the axial direction, and an inner groove wall on an inner side in the axial direction,
a second boundary between the groove bottom and the outer groove wall is a reference position of the first shoulder circumferential groove,
a distance in the axial direction from the reference position of the first shoulder circumferential groove to the first boundary end is not less than 3 mm, and
a ratio of the distance in the axial direction to a ground-contact width of the first shoulder land portion is not greater than 20%.

3. The tire according to claim 1, wherein, in a meridian cross-section of the tire, a distance in the axial direction from an equator plane to the first boundary between the outer cap portion and the inner cap portion gradually increases from the first boundary end toward the second boundary end.

4. The tire according to claim 3, wherein, in the meridian cross-section of the tire, an angle formed between a straight line passing through the first boundary end and the second boundary end and a tangent line tangent to the tread surface at the first boundary end is not less than 5 degrees and not greater than 80 degrees.

5. The tire according to claim 1, wherein the 300% modulus of the outer cap portion is not less than 8.0 MPa.

6. The tire according to claim 1, wherein the 300% modulus of the inner cap portion is not greater than 7.0 MPa.

7. The tire according to claim 1, wherein a ratio of the 300% modulus of the outer cap portion to the 300% modulus of the inner cap portion is not less than 1.1.

8. The tire according to claim 1, wherein, in a meridian cross-section of the tire, a contour line of the first boundary between the outer cap portion and the inner cap portion is curved toward the base portion side.

9. The tire according to claim 2, wherein, in a meridian cross-section of the tire, positions of the first boundary end and the second boundary end coincide with each other in the axial direction.

10. The tire according to claim 1, wherein the first shoulder circumferential groove extends in the inner cap portion in a radial direction without extending into the outer cap portion or the base portion.

11. The tire according to claim 1, wherein
a first end, on the tread surface side, of the first boundary between the outer cap portion and the inner cap portion is a first boundary end,
a second end, on the base portion side, of the first boundary is a second boundary end,
the first boundary end is at the tread surface, and
the second boundary end is at an interface between the base portion and the cap portion.

12. The tire according to claim 1, wherein
the outer cap portion is formed of a first crosslinked rubber, and
the inner cap portion is formed of a second crosslinked rubber different from the first crosslinked rubber.

13. The tire according to claim 1, wherein
the first shoulder circumferential groove includes a groove bottom, an outer groove wall on an outer side in the axial direction, and an inner groove wall on an inner side in the axial direction, and
a first angle of the outer groove wall is greater than a second angle of the inner groove wall.

14. The tire according to claim 1, wherein
a first end, on the tread surface side, of the first boundary between the outer cap portion and the inner cap portion is a first boundary end,
the first shoulder circumferential groove includes an outer groove wall on an outer side in the axial direction and an inner groove wall on an inner side in the axial direction, and
the first boundary end is spaced apart from the outer groove wall at the tread surface.

15. The tire according to claim 1, wherein
a first end, on the tread surface side, of the first boundary between the outer cap portion and the inner cap portion is a first boundary end,
a second end, on the base portion side, of the first boundary is a second boundary end, and
the first boundary extends linearly continuously from the first boundary end to the second boundary end.

16. A tire comprising a tread extending in a circumferential direction and having an outer circumferential surface that is a tread surface, wherein
the tread has a plurality of circumferential grooves aligned in an axial direction and dividing the tread into a plurality of land portions,
the plurality of circumferential grooves include a first shoulder circumferential groove on a first side in the axial direction, and a second shoulder circumferential groove on a second side in the axial direction,
the land portion outward of the first shoulder circumferential groove in the axial direction is a first shoulder land portion,
the land portion outward of the second shoulder circumferential groove in the axial direction is a second shoulder land portion,
the tread includes a cap portion to come into contact with a road surface, and a base portion radially inward of the cap portion and covered with the cap portion,
the cap portion includes an outer cap portion on the outer side in the width direction of the vehicle, and an inner cap portion on the inner side in the width direction,
a 300% modulus of the inner cap portion is not less than 5.0 MPa,
a 300% modulus of the outer cap portion is higher than the 300% modulus of the inner cap portion, and is not greater than 9.0 MPa, the first shoulder land portion includes a first boundary between the outer cap portion and the inner cap portion,
a first end, on the tread surface side, of the first boundary between the outer cap portion and the inner cap portion is a first boundary end,
a second end, on the base portion side, of the first boundary is a second boundary end,
the first shoulder circumferential groove includes a groove bottom, an outer groove wall on an outer side in the axial direction, and an inner groove wall on an inner side in the axial direction,
a second boundary between the groove bottom and the outer groove wall is a reference position of the first shoulder circumferential groove,
a distance in the axial direction from the reference position of the first shoulder circumferential groove to the first boundary end is not less than 3 mm,
a ratio of the distance in the axial direction to a ground-contact width of the first shoulder land portion is not greater than 20%, and
in a meridian cross-section of the tire, a contour line of the first boundary between the outer cap portion and the inner cap portion is curved toward the base portion side.

17. The tire according to claim 16, wherein the first shoulder circumferential groove extends in the inner cap portion in a radial direction without extending into the outer cap portion or the base portion,
a first end, on the tread surface side, of the first boundary between the outer cap portion and the inner cap portion is a first boundary end,
a second end, on the base portion side, of the first boundary is a second boundary end,
the first boundary end is at the tread surface, and
the second boundary end is at an interface between the base portion and the cap portion.

18. The tire according to claim 16, wherein
the outer cap portion is formed of a first crosslinked rubber,
the inner cap portion is formed of a second crosslinked rubber different from the first crosslinked rubber,
a first end, on the tread surface side, of the first boundary between the outer cap portion and the inner cap portion is a first boundary end,
the first shoulder circumferential groove includes an outer groove wall on an outer side in the axial direction and an inner groove wall on an inner side in the axial direction, and
the first boundary end is spaced apart from the outer groove wall at the tread surface.

19. A tire comprising a tread extending in a circumferential direction and having an outer circumferential surface that is a tread surface, wherein
the tread has a plurality of circumferential grooves aligned in an axial direction and dividing the tread into a plurality of land portions,
the plurality of circumferential grooves include a first shoulder circumferential groove on an outer side in a width direction of a vehicle when the tire is mounted to a vehicle, and a second shoulder circumferential groove on an inner side in the width direction of the vehicle when the tire is mounted to the vehicle,
the land portion outward of the first shoulder circumferential groove in the axial direction is a first shoulder land portion,
the land portion outward of the second shoulder circumferential groove in the axial direction is a second shoulder land portion,
the tread includes a cap portion to come into contact with a road surface, and a base portion radially inward of the cap portion and covered with the cap portion,
the cap portion includes an outer cap portion on the outer side in the width direction of the vehicle, and an inner cap portion on the inner side in the width direction,
a 300% modulus of the inner cap portion is not less than 5.0 MPa,
a 300% modulus of the outer cap portion is higher than the 300% modulus of the inner cap portion, and is not greater than 9.0 MPa,
the first shoulder land portion includes a first boundary between the outer cap portion and the inner cap portion,
a first end, on the tread surface side, of the first boundary between the outer cap portion and the inner cap portion is a first boundary end,
a second end, on the base portion side, of the first boundary is a second boundary end,
the first shoulder circumferential groove includes a groove bottom, an outer groove wall on an outer side in the axial direction, and an inner groove wall on an inner side in the axial direction,
a second boundary between the groove bottom and the outer groove wall is a reference position of the first shoulder circumferential groove,
a distance in the axial direction from the reference position of the first shoulder circumferential groove to the first boundary end is not less than 3 mm,
a ratio of the distance in the axial direction to a ground-contact width of the first shoulder land portion is not greater than 20%, and
in a meridian cross-section of the tire, positions of the first boundary end and the second boundary end coincide with each other in the axial direction.

20. The tire according to claim 16, wherein
a first end, on the tread surface side, of the first boundary between the outer cap portion and the inner cap portion is a first boundary end,
the first shoulder circumferential groove includes an outer groove wall on an outer side in the axial direction and an inner groove wall on an inner side in the axial direction, and
the first boundary end is spaced apart from the outer groove wall at the tread surface.
